(19) United States
(12) Patent Application Publication
(10) Pub. No.: US 2024/0261966 A1
(43) Pub. Date: Aug. 8, 2024

(54) Method for the decentralised operation of a production plant for manufacturing, producing and/or assembling products and/or goods, and a production plant that can be operated according to such a method

(71) Applicant: Schwäbische Werkzeugmaschinen GmbH, Schramberg-Waldmössingen (DE)

(72) Inventors: Nicholas VOIGT, Rottweil (DE); Hendrik JACOBSEN, Köln (DE); Daniel HAAG, Dunningen (DE)

(73) Assignee: Schwäbische Werkzeugmaschinen GmbH, Schramberg-Waldmössingen (DE)

(21) Appl. No.: 18/429,691

(22) Filed: Feb. 1, 2024

(30) Foreign Application Priority Data
Feb. 3, 2023 (EP) 23154984.1

(51) Int. Cl. B25J 9/16

(52) U.S. Cl. CPC B25J 9/1661; B25J 9/1653

(57) ABSTRACT

A method for decentralised operation of a production system for producing, manufacturing and/or assembling products and/or goods, which includes at least three participants in a production environment, in which each participant includes a computing unit, in which a skill spectrum can be detected by the respective participant, and wherein each participant comprises a transmitting and receiving unit for transmitting and receiving electromagnetic waves.

This application claims the benefit of European application EP23154984.1, filed Feb. 3, 2023, which is incorporated herein by reference.

The invention relates to a method for the decentralised operation of a production plant for manufacturing, producing and/or assembling products and/or goods and a production plant that can be operated according to such a method.

Production systems for manufacturing, producing and/or assembling products and/or goods are known from the state of the art in various embodiments. In these, a manufacturing process, a production process and/or an assembly process is generally controlled centrally so that a central, higher-level production system of the production plant assigns tasks to the individual participants for the processing of a production order.

If participants in the production environment become unavailable, for example due to a technical fault or an unforeseeable event, this participant must be replaced by the central system in a complex process, or the tasks of the unavailable participant must be distributed to other participants in the production environment.

The same is true if it is possible to integrate new participants into the production environment, for example by adding autonomous vehicles that are relocated from one production environment to another without planning.

One task of one embodiment of the invention is to propose a method for the decentralised operation of a production plant for manufacturing, producing and/or assembling products and/or goods and a production plant that can be operated according to such a method, for which the processing of a production order can be organised more flexibly.

This task is solved by a method for decentralised operation of a production system for producing, manufacturing and/or assembling products and/or goods, which comprises at least three participants in a production environment, each participant comprising a computing unit in which a skill spectrum can be detected by the respective participant, and each participant comprising a transmitting and receiving unit for transmitting and receiving electromagnetic waves, with the following steps:
a. Acceptance of a production order comprising at least one task from a production system of the production plant by a participant who constitutes a production participant;
b. The production participant identifies a task of the at least one task that is outside the skill spectrum and transmits the identified task to the production environment;
c. Receipt of the sent task by at least one other participant in the production environment and checking by the participant whether the performance of the task is within the participant's skill spectrum;
d. Transmission to the production environment of an offer to perform the task by at least one auxiliary participant formed by one of the further participants, where the performance of the task is within the skill spectrum of the participant; and
e. Determining the auxiliary participant whose skill spectrum is most suitable for performing the task and performing the task by the determined auxiliary participant.

When the production participant transmits a task to the production environment, where it is received and analysed by another participant, an offer is made to the participants in the production environment to accept a task.

As the individual participants can check this offer and can determine whether they can accept the task and, if so, submit an offer to accept the task, which can be accepted and the task transferred to the participant, this provides a decentralised method for operating the production plant. This enables the task of a participant to be distributed automatically and independently by the remaining participants in the production environment if a participant fails, without this having to be controlled centrally and/or without adjustments having to be made to the control system. This allows independent organisation of the system in changing framework conditions.

The addition of further participants is also guaranteed in a simple manner.

Thus, the participants organise themselves without this needing to be controlled centrally.

The production plan may for example, be a machine park with one or more machine tools or machining centres.

Also, the production plan may be an assembly line on which a finished product is formed from several components and/or assembly groups.

Furthermore, the production plant may be a bulk materials plant.

Step e. can in principle be carried out as desired, provided that an auxiliary participant is identified that is suitable and/or most suitable for performing the task.

In one embodiment of the method, it proves to be beneficial if, in step e., the auxiliary participant is determined by a decentralised bidding procedure in which each participant in the production environment, where the performance of the task lies within its skill spectrum, forms a potential auxiliary participant, with the steps:
a. Transmission of an offer to accept the task by all potential auxiliary participants to the production environment, including information on the relevant skills in the skill spectrum for performing the task;
b. Receipt of all offers by each potential auxiliary participant in the production environment and comparison of the received offers with the own offer by the potential auxiliary participants, if at least two participants each form a potential auxiliary participant;
c. Withdrawal of the own offer by the potential auxiliary participants whose own offer is less suitable than the received offer of at least one other potential auxiliary participant, if at least two participants each form a potential auxiliary participant, whereby the potential auxiliary participant with the most suitable offer forms the auxiliary participant; and
d. Transmission of the offer of the only auxiliary participant at least to the production participant if only one participant forms an auxiliary participant, whereby the only potential auxiliary participant forms the auxiliary participant, or sending of the offer of the remaining auxiliary participant to the production participant if at least two participants each form a potential auxiliary participant.

Because the potential auxiliary participants check each other's offers and withdraw their own offer if at least one offer from another potential auxiliary participant is better, the potential auxiliary participants coordinate with one another.

This means that no central unit is required that evaluates the individual offers; rather, the offers are evaluated by the individual auxiliary participants. In addition, there is no need for a central unit to keep a record of the skills, in particular the spectrum of skills, of the individual auxiliary participants, as the individual auxiliary participants decide autonomously and for themselves whether their own skills are sufficient to perform the task.

An auxiliary participant is a participant that accepts the task sent to the production environment by a production participant and assists the production participant.

The offer of the single auxiliary participant can be sent not only to the production participant, but also to the production environment, in particular to the other potential auxiliary participants.

A potential auxiliary participant is a participant who applies for the role of auxiliary participant in the course of the bidding process. If the participant determines that the task offered is within its skill spectrum, it automatically becomes a potential auxiliary participant, with the final choice of auxiliary participant being determined at the end of the bidding process.

As an alternative to the last named embodiment of the method, one variation of the method may be when the auxiliary participant is determined by a central bidding procedure in which each participant in the production environment, where the performance of the task lies within its skill spectrum, forms a potential auxiliary participant, with the steps:
a. Transmission of an offer to accept the task by all potential auxiliary participants to the production environment, including information on the relevant skills in the skill spectrum for performing the task;
b. Receipt of the offer of the individual or all potential auxiliary participants by the production participant and/or by the higher-level production system and, if necessary, comparison of the offers of the potential auxiliary participants if at least two participants each form a potential auxiliary participant;
c. Determination of the auxiliary participant formed by the potential auxiliary participant whose offer is most suitable for performing the task by the production participant and/or by the higher-level production system; and
d. Transmission of an offer from a specific auxiliary participant to at least the production participant that is most suitable for performing the task and withdrawal of offers from other potential auxiliary participants.

In this variant, the individual participants who have determined that they can accept the offered task transmit their offer to the higher-level production system. The evaluation then takes place there of which offer will be accepted and which potential auxiliary participant will be named the auxiliary participant. A bidder procedure takes place here also.

The offer of the single auxiliary participant can be sent not only to the production participant, but also to the production environment, in particular to the other potential auxiliary participants.

Decentralised operation of the production plant also takes place in the central bidding process, as the decision as to which participant becomes a potential auxiliary participant is made individually by each participant. This is scalable and increases the flexibility of the production plant.

In embodiments of the method, it is conceivable that at least one of the at least one task of the production order is defined and predetermined by the production system of the production plant and/or that the production participant performs an analysis of the production order and defines at least one of the at least one task to fulfil the production order on the basis of the analysis.

If at least one of the at least one task of the production order is defined and specified by the production system of the production plant, the production participant can have a simplified technical design, in particular with regard to sensors or hardware.

If the production participant performs an analysis of the production order and defines at least one of the at least one task for fulfilling the production order based on the analysis, the production participant can decide and identify for which activity, i.e. for which task, it must resort to an auxiliary participant. This extends the decentralised operation of the process, since the definition of tasks does not have to be assigned centrally, but rather the tasks are identified by the individual participants themselves.

In principle the decentral bidder process and/or the central bidder process can be open ended. In order to achieve prompt decision-making, in particular the assignment of tasks, it has proven beneficial if the comparative offer is made by the potential auxiliary participants or by the production participant and/or by the higher-level production system after a period of at least one second, in particular of at least five seconds, in particular of at least ten seconds, in particular of at least thirty seconds, after a potential auxiliary participant has transmitted the offer to perform the task.

This can prevent late decision making.

The skills in the skills spectrum of the individual participants are understood to be the skills required to perform a task or a production order. In one embodiment of the method, it proves beneficial if the skills of the skill spectrum comprise the movement capability, speed, energy and/or fuel reserve, gripping capability, depositing capability, loading options of the participant with tools, order and/or work status, processing options of products and/or goods, carrying capacity and/or free loading capacity and/or free loading volume, environmental information, distance to the production participant and the possibility of parallel processing.

The skills named above are an open list and further skills can be added.

Further evaluation factors can be added besides the skills of the individual auxiliary participants. In a further development of the method, it is envisaged that the comparison of the offer with the own offer by the respective potential auxiliary participant would additionally comprise the following influencing factors and/or operating strategy options:
a. Detecting alternative solutions for performing the task in the offers of the other potential auxiliary participants;
b. Evaluation of the alternative solutions; and
c. Identification and selection of the most suitable alternative solution.

Different operating strategy options can be detected and evaluated.

One operating strategy option, for example, is to perform the task and/or the production order in a particularly energy-saving manner. A further operating strategy option could be to perform the task as quickly as possible. A further strategy option could be an optimal loading of all participants present.

In order to be able to record the most suitable offer of the individual potential auxiliary participants, it proves beneficial in one embodiment of the method if the comparison of the offer with the own offer by the respective potential auxiliary participant also includes a weighting and/or weightings of the individual skills of the participants stored in the computing unit.

In this case the individual skills of the participants can be allocated different weightings or emphases. For example, the influence factor speed of the auxiliary participant can be given greater emphasis for a particularly fast processing strategy option than available energy and/or fuel reserve or particularly low-energy operation of the auxiliary participant.

In principle, the auxiliary participant can be formed by any participant in the production environment. In embodiments of the method, it proves beneficial if at least one auxiliary participant comprises a robot, a storage system or a transport system such as an autonomous guided vehicle (AGV), and/or that at least one production participant comprises a processing machine or an assembly station.

In addition, embodiments of the method are conceivable in which the potential auxiliary participant transmitting an offer to perform the task is free of orders or that the potential auxiliary participant transmitting an offer to perform the task is processing a task that has already been accepted.

If the participant who receives an offer to perform the task is free of orders, the participant can start working on the task immediately when the order is assigned or awarded to the participant.

If the participant transmitting an offer to perform the task is currently working on a task that has already been accepted, participants who are not currently free of orders can also take part in the bidding process.

In a further development of the latter embodiment, it proves beneficial if, when the new task is accepted, the potential auxiliary participant currently processing pauses the active processing of the previous task already accepted when the new task is assigned until the processing of the new task is completed or transmits the previous task to the production environment for acceptance by another potential auxiliary participant.

If this is the case, the participant currently processing can pause the currently active task or transmit the currently active task to the production field for acceptance by another participant as part of the bidding process and thereby offer it.

Both measures allow the participant who is most suitable to perform the task to be found.

In addition, in a further development of the latter embodiment, it is provided that the potential auxiliary provider currently processing only accepts the new task and/or only transmits an offer to perform the task if the new task sent by the production participant has a higher priority than the active previous task and/or if all other potential auxiliary participants are significantly less suitable for processing the task.

In such cases, the potential auxiliary participant decides whether the new task is more important than the task already being processed before taking on a task and/or before transmitting an offer to perform the task.

This further improves the efficient operation of the production plant.

In order to improve the evaluation of the task, it proves beneficial if the task includes information about necessary skills, weightings and/or emphases of the participant's skills as well as information about influencing factors and/or operating strategy options and/or if the participant carries out an evaluation of the task and an analysis, identification and/or interpretation of the skills necessary to solve the task.

This makes it easier for the individual participants to evaluate whether the task is within its own spectrum of skills.

In principle the task can be organised in any way. In embodiments of the method, it is envisaged that the task comprises processing, transporting, loading and unloading or storing products, goods, parts, bulk material, workpieces, a pallet/tray, a device, a gripper and/or a tool.

Furthermore, it proves beneficial if at least one of the at least three participants each comprises a machine-detectable and/or user-detectable information element.

If at least one of the at least three participants comprises a machine-detectable and/or user-detectable information element, the at least one participant is passively detectable, i.e. not recognisable as such by itself, but by the other participants. The machine-detectable information element can, for example, comprise a code, in particular a bar code, QR code or similar. The user-detectable information element can comprise a label and/or an image element.

Finally, this task is solved by a production plant for the manufacturing, producing and/or assembly of products and/or goods that includes at least three participants in a production environment, whereby each participant is a computing unit in which the relevant participant can detect a skill spectrum and whereby each participant includes a sending and receiving unit to transmit and receive electromagnetic waves that can be operated according to a method with at least one of the above-named characteristics.

Further features, details and advantages of the invention result from the attached patent claims, from the graphic representation and subsequent description of a preferred embodiment of the production plant and the method.

The drawing shows:

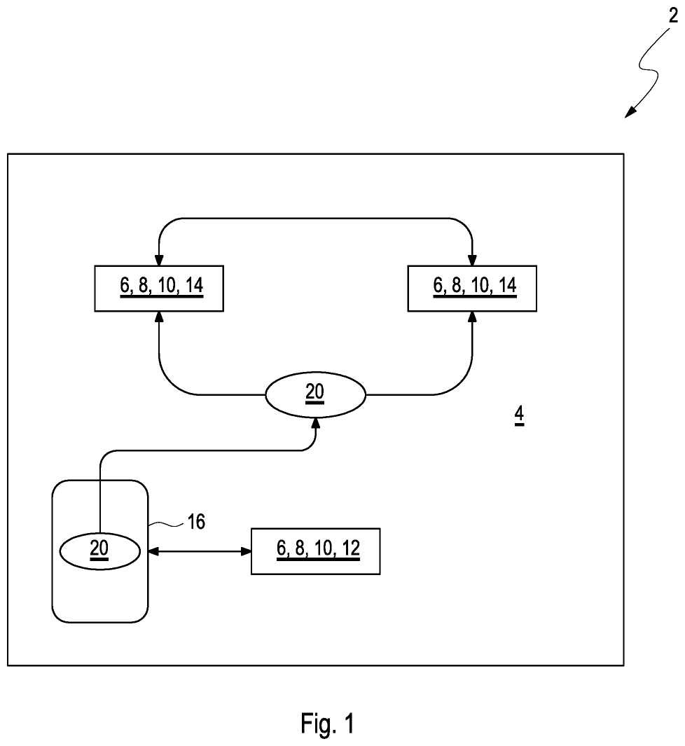

FIG. 1A schematic illustration of a production plan in accordance with the invention;

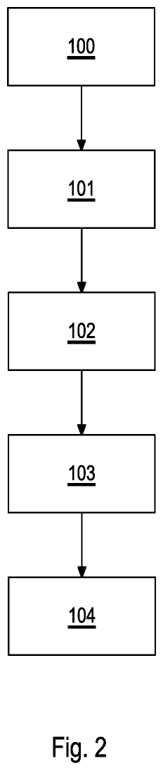

FIG. 2A schematic flow diagram of a method according to the invention;

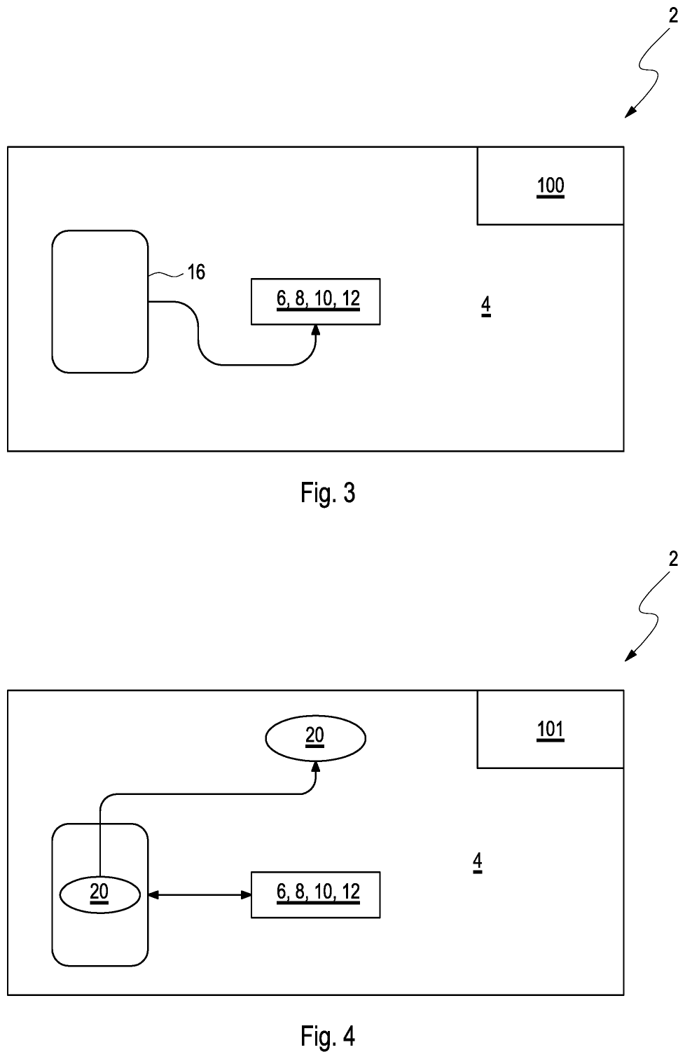

FIG. 3A first step of the method in accordance with FIG. 2 with the involved components in accordance with FIG. 1;

FIG. 4A second step of the method in accordance with FIG. 2 with the involved components in accordance with FIG. 1;

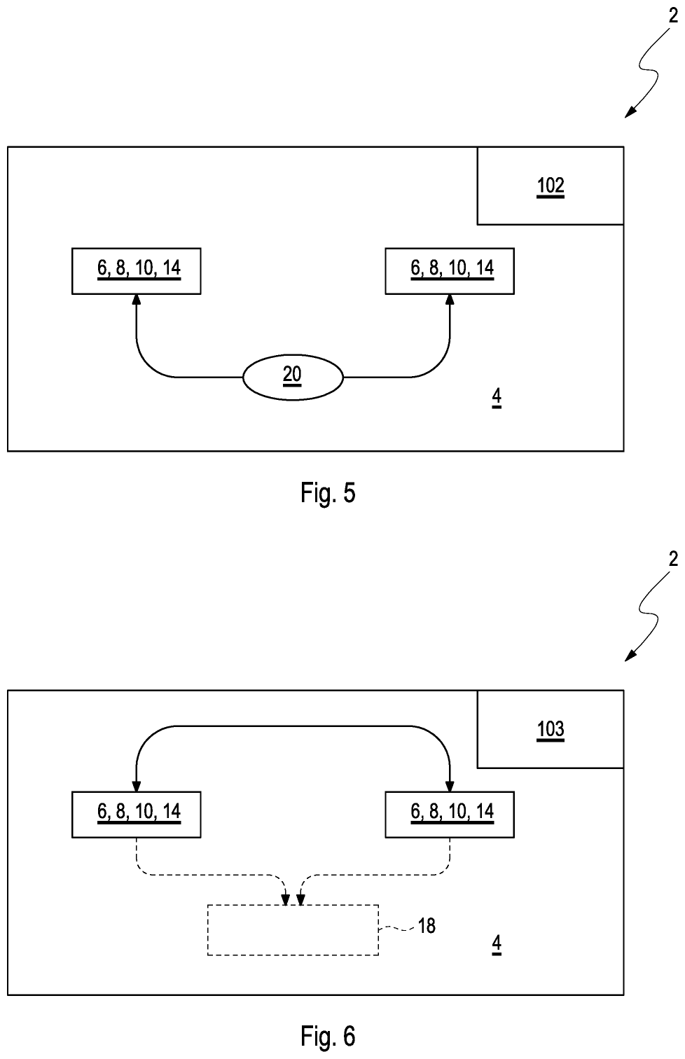

FIG. 5A third step of the method in accordance with FIG. 2 with the involved components in accordance with FIG. 1;

FIG. 6A fourth step of the method in accordance with FIG. 2 with the involved components in accordance with FIG. 1;

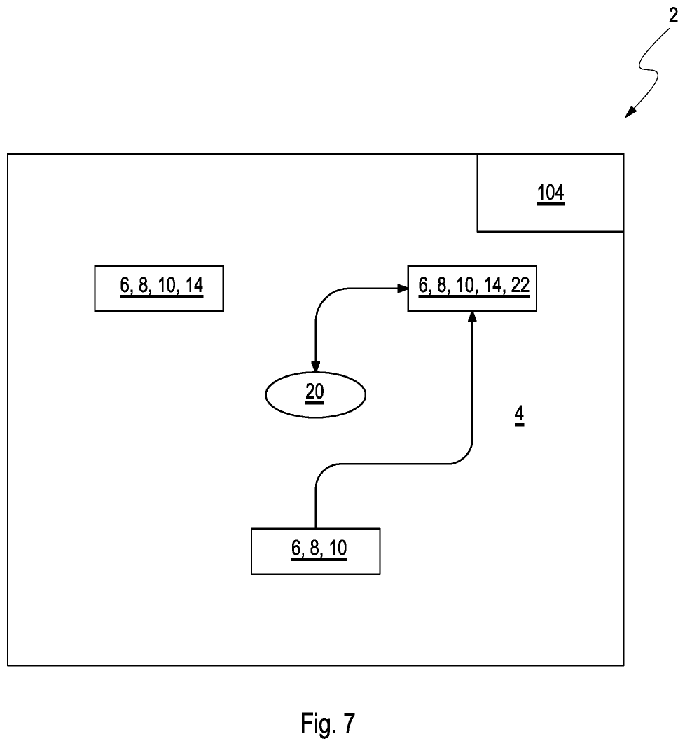

FIG. 7A fifth step of the method in accordance with FIG. 2 with the involved components in accordance with FIG. 1.

FIG. 1 shows a production plant labelled with the reference symbol 2 for manufacturing, producing and/or assembling products and/or goods.

Production plant 2 comprises a production environment 4, in which at least three participants 6 are arranged. Each participant 6 comprises a computer unit 8, in which the relevant participant 6 can detect a spectrum of skills.

In addition, each participant 6 comprises a transmitting and receiving unit 10 to transmit and receive electromagnetic waves.

FIG. 1 shows the production system 2, in which one of the three participants 6 forms a production participant 12 and the two remaining participants 6 form a potential auxiliary participant 14.

FIG. 2 shows a schematic flow chart of the method according to the invention.

The method is described below with reference to the overall illustration in FIG. 1 and the illustration of the individual steps 100 to 104 in FIGS. 3 to 7.

In a first step 100 (see also FIG. 3), a production order 16 from a production system 18 (shown in FIG. 6) is accepted by one of the participants 6. This participant 6 forms the production participant 12 in this case.

The acceptance of the production order 16 by the production participant 12 may involve assigning the production order 16 to one of the participants 6, or one of the participants 6 may apply and accept the production order 16 as part of a bidding process.

In a subsequent step 101 (see also FIG. 4), a task 20 of the production order 16 is identified by the production participant 12, which lies outside the skill spectrum of the production participant 12.

This task 20, which is outside the skill spectrum of the production participant 12, is sent to the production environment 4.

In a subsequent step 102 (see also FIG. 5), the transmitted task 20 is received by at least one further participant 6 in the production environment 4 and checked by the participant 6 as to whether the performance of the task 20 is within the skill spectrum of the respective participant 6.

In a subsequent step 103 (see also FIG. 6), an offer to perform the task 20 is sent to the production environment 4 by at least one auxiliary participant 22. The auxiliary participants 22 are formed by the participants 6 for whom the performance of the task 20 is within the respective skill spectrum of the respective participant 6.

Looking at FIG. 6, the transmission of the offer can have different performance options. The transmission of the offer for the performance of task 20 in a so-called decentralised bidding procedure is shown with a solid line. In this process, the other participants 6 receive the offer from the other participants 6 for whom the performance of the task 20 is within their skill spectrum. In this process, all offers are received by each potential auxiliary participant 14 and compared with their own offer.

If the offer of another potential auxiliary participant 14 is more suitable for performing the task 20 than the own offer, the own offer is cancelled. The only remaining potential auxiliary participant 14, i.e. the potential auxiliary participant 14 whose offer is most suitable for performing the task 20, becomes auxiliary participant 22.

FIG. 6 also shows another option in the form of a centralised bidding process (shown as a dashed line). The offers to accept the task 20 from the individual potential auxiliary participants 14 are sent to the higher-level production system 18 and analysed by it. In such cases, the central production system 18 identifies the potential auxiliary participant 14 whose offer is most suitable for solving the task 20 and appoints this participant as auxiliary participant 22.

In a final step 104 (see also FIG. 7), the auxiliary participant 22 whose skill set is most suitable for performing the task 20 is determined. The task 20 is then performed by this specific auxiliary participant 22.

The features of the invention disclosed in the foregoing description, in the claims as well as in the drawing, both individually and in any combination, may be essential in the realisation of the invention in its various embodiments within the scope of protection of the following claims.

### LIST OF REFERENCE SYMBOLS

2 Production plant
4 Production environment
6 Participant
8 Computer unit
10 Transmission and reception unit
12 Production participant
14 Potential auxiliary participant
16 Production order
18 Production system
20 Task
22 Auxiliary participant
100-104 Process steps

1. A method for decentralised operation of a production plant for producing, manufacturing and/or assembling products and/or goods, which comprises at least three participants in a production environment, each participant comprising a computing unit, in which a skill spectrum can be detected by the respective participant, and each participant comprising a transmitting and receiving unit for transmitting and receiving electromagnetic waves, the method comprising the following steps:
acceptance of a production order comprising at least one task from a production system of the production plant by a participant who forms a production participant;
identification by the production participant of a task of the at least one task that lies outside the skill spectrum and transmission of the identified task to the production environment;
receipt of the transmitted task by at least one other participant in the production environment and checking by the participant whether the performance of the task is within the participant's skill spectrum;
transmission of an offer to perform the task by at least one auxiliary participant into the production environment, which is formed by one of the further participants, in which the performance of the task is within the skill spectrum of the participant; and
determining the auxiliary participant whose skill spectrum is most suitable for performing the task and performance of the task by the determined auxiliary participant.

2. The method according to claim 1, wherein the auxiliary participant is determined by a decentralised bidding process, in which each participant in the production environment, in which the execution of the task lies within its production spectrum, forms a potential auxiliary participant, with the steps:
transmission by all potential auxiliary participants to the production environment of a respective offer to perform the task, comprising information on relevant skills of the skill spectrum for performing the task;
receipt of all offers by each potential auxiliary participant in the production environment and comparison of the received offers with the own offer by the potential auxiliary participants, if at least two participants each form a potential auxiliary participant;
withdrawal of the own offer by the potential auxiliary participants whose own offer is less suitable than the received offer of at least one other potential auxiliary participant, if at least two participants each form a potential auxiliary participant, whereby the potential auxiliary participant with the most suitable offer forms the auxiliary participant; and
transmission of the offer of the only auxiliary participant at least to the production participant if only one participant forms an auxiliary participant, wherein the only potential auxiliary participant forms the auxiliary participant, or transmission of the offer of the remaining auxiliary participant to the production participant if at least two participants each form a potential auxiliary participant.

3. The method according to claim 1, wherein the auxiliary participant is determined by a centralised bidding process, in which each participant in the production environment, in which the performance of the task lies within its production spectrum, forms a potential auxiliary participant, with the steps:
transmission by all potential auxiliary participants to the production environment of a respective offer to perform the task, comprising information on relevant skills of the skill spectrum for performing the task;
receipt of the offer of the only or all potential auxiliary participants by the production participant and/or by the higher-level production system and, if necessary, comparison of the offers of the potential auxiliary participants if at least two participants each form a potential auxiliary participant;
determination of the auxiliary participant formed by the potential auxiliary participant whose offer to perform the task is most suitable by the production participant and/or by the higher-level production system; and
transmission of an offer from a specific auxiliary participant to at least the production participant that is most suitable for performing the task and withdrawal of offers from other potential auxiliary participants.

4. The method according to claim 1, wherein at least one task of the production order is defined and specified by the production system of the production plant and/or in that the production participant carries out an analysis of the production order and independently defines at least one of the at least one task for fulfilling the production order on the basis of the analysis.

5. The method according to claim 1, wherein the skills of the skill spectrum comprise the possibility of movement, speed, energy and/or fuel reserve, gripping ability, storage ability, loading options of the participant with tools, order and/or work status, processing options of products and/or goods, load capacity and/or free loading capacities and/or free loading volume, environment information, distance to the production participant and possibility of parallel processing.

6. The method according to claim 1, wherein the comparison of the offer with the own offer by the respective potential auxiliary participant additionally comprises the following influencing factors and/or operating strategy options:
detecting alternative solutions for performing the task in the offers of the other potential auxiliary participants;
evaluation of the alternative solutions; and
identification and selection of the most suitable alternative solution.

7. The method according to claim 1, wherein the comparison of the offer with the own offer by the respective potential auxiliary participant additionally comprises a weighting and/or emphases of the individual skills of the participants stored in the computing unit.

8. The method according to claim 1, wherein at least one auxiliary participant comprises a robot, a storage system or a transport system such as an autonomous guided vehicle (AGV), and/or in that at least one production participant comprises a processing machine or an assembly station.

9. The method according to claim 1, wherein the potential auxiliary participant transmitting an offer to perform the task is free of orders or in that the potential auxiliary participant transmitting an offer to perform the task is in the midst of processing a task that has already been accepted.

10. The method according to claim 9, wherein, when the new task is accepted, the potential auxiliary participant currently processing pauses the active processing of the already accepted previous task when the new task is assigned until the processing of the new task is completed, or transmits the previous task to the production environment for acceptance by a further potential auxiliary participant.

11. The method according to claim 9, wherein the potential auxiliary participant currently processing only accepts the new task and/or only transmits an offer to perform the task if the new task transmitted by the production participant has a higher priority than the active previous task and/or if all other potential auxiliary participants are significantly less suitable for processing the task.

12. The method according to claim 1, wherein the task comprises information about necessary skills, weightings and/or emphases of the skills of the participant as well as information about influencing factors and/or operating strategy options and/or in that the participant performs an evaluation of the task and an analysis, identification and/or interpretation of the skills necessary for solving the task.

13. The method according to claim 1, wherein the task comprises processing, transporting, loading and unloading or storing products, goods, parts, bulk material, workpieces, a pallet/tray, a device, a gripper and/or a tool.

14. The method according to claim 1, wherein at least one of the at least three participants each comprise a machine-detectable and/or user-detectable information element.

15. A production plant for producing, manufacturing and/or assembling products and/or goods, which comprises at least three participants in a production environment, wherein each participant comprises a computing unit, in which a skill spectrum can be detected by the respective participant, and wherein each participant comprises a transmitting and receiving unit for transmitting and receiving electromagnetic waves, which can be operated according to a method of claim 1.
